(19) United States
(12) Patent Application Publication
(10) Pub. No.: US 2009/0126586 A1
(43) Pub. Date: May 21, 2009

(54) Method and Device for Gravure Printing Using an Erasable and Re-Usable Printing Form

(75) Inventors: Hartmut Fuhrmann, Bobingen (DE); Mladen Frlan, Gersthofen (DE)

Correspondence Address: COHEN, PONTANI, LIEBERMAN & PAVANE LLP, 551 FIFTH AVENUE, SUITE 1210, NEW YORK, NY, 10176, US

(73) Assignee: MAN ROLAND DRUCKMASCHINEN AG, Offenbach am Main (DE)

(21) Appl. No.: 12/084,391

(22) PCT Filed: Oct. 27, 2006
(86) PCT No.: PCT/EP2006/010360

§ 371 Date: Jul. 14, 2008

(30) Foreign Application Priority Data
Nov. 2, 2005 (DE) 10 2005 052 156.8

(51) Int. Cl. B41M 1/10

(52) U.S. Cl. 101/170

(57) ABSTRACT

The invention relates to a method and a device for gravure painting using an enable and re-usable printing form. The starting point of said method is a gravure printing form comprising a basic grid that is designed for the maximum quality of ink that is transferred, said grid being uniformly filled in a filling process, a pattern being created by thermal ablation and the gravure printing form being erased after the printing process. The aim of the invention is to provide a method and device with which the complete removal of the filler material can be performed in a justifiable time in a reliable manner, even outside the printing press. To achieve this, the filler material and the residual ink is removed by a separate laser beam from that of the image-point transfer device.

The invention pertains to a process and to a device for gravure printing using an erasable and reusable gravure form based on a blank gravure form with a basic screen designed to accept at least the maximum amount of ink to be transferred.

The gravure printing process is an especially simple process, which is characterized in that the inking does not first have to reach a state of equilibrium as is usually the case in offset single-color systems; on the contrary, it provides the substrate with the correct amount of ink almost immediately. A very high level of print quality is achieved with gravure printing, and an extremely wide variety of substrates can be printed. Counting against this advantage is the considerable amount of effort usually required to produce a gravure form.

Erasable gravure forms, the production of which has already been greatly simplified, are known from EP 0 730 953 B1.

Thus, a prestructured blank gravure form with a basic screen designed to accept at least the maximum amount of ink to be transferred is filled in a first step with a filler substance using an applicator device. The filler substance can be a thermoplastic resin or a wax, a varnish, or a crosslinkable polymer melt or solution, which is also called a “reactive system” and which is characterized by an extremely high degree of abrasion resistance. The surface of the gravure form is then essentially smooth. Then the filler substance is removed from the recessed cells in accordance with the desired image by the thermal energy of an image point transfer device. Now the gravure form can be inked by means of an inking system, so that the substrate can be printed

The invention pertains to a process and to a device for gravure printing using an erasable and reusable gravure form based on a blank gravure form with a basic screen designed to accept at least the maximum amount of ink to be transferred.

The gravure printing process is an especially simple process, which is characterized in that the inking does not first have to reach a state of equilibrium as is usually the case in offset single-color systems; on the contrary, it provides the substrate with the correct amount of ink almost immediately. A very high level of print quality is achieved with gravure printing, and an extremely wide variety of substrates can be printed. Counting against this advantage is the considerable amount of effort usually required to produce a gravure form.

Erasable gravure forms, the production of which has already been greatly simplified, are known from EP 0 730 953 B1.

Thus, a prestructured blank gravure form with a basic screen designed to accept at least the maximum amount of ink to be transferred is filled in a first step with a filler substance using an applicator device. The filler substance can be a thermoplastic resin or a wax, a varnish, or a crosslinkable polymer melt or solution, which is also called a “reactive system” and which is characterized by an extremely high degree of abrasion resistance. The surface of the gravure form is then essentially smooth. Then the filler substance is removed from the recessed cells in accordance with the desired image by the thermal energy of an image point transfer device. Now the gravure form can be inked by means of an inking system, so that the substrate can be printed by the gravure process. After printing is complete, the surface of the gravure form is regenerated by cleaning off the ink residues; by removing the filler substance, preferably completely, from the prestructured cells; and by filling the cells uniformly again. The filler substance can be removed from the prestructured cells by means of a heat source and/or an air-blast device or a suction device.

After the cells between the cell walls of the gravure form have been filled with the filler substance in the form of a thermoplastic, the desired image can be “burned” into the gravure form by the thermal energy of an image point transfer unit, especially by means of a laser, in analogy to an external drum platesetter. NdYAG or NdYLF lasers are preferably used, which can be switched between several intensity levels by means of an acousto-optic modulator.

Inside a gravure press is a device for applying a filler substance directly to a gravure form cylinder, which carries the gravure form. The position of this applicator device is adjustable. After the filler has been ablated from the blank gravure form in accordance with the desired image, the resulting gravure form can be inked by an inking system. A chamber blade with an ink outlet is preferably used for this purpose, because it occupies less space on the circumference of the cylinder than a conventional inking system and because it can be easily moved away from the gravure cylinder during the other steps of the process.

After the required printing process has been completed, the gravure form is cleaned of ink residues by a regeneration device, preferably in the form of an ultrasonic cleaning system, which is also designed so that it can be brought up to the form and moved away from it again in the same way as the ink chamber blade. Then the filler substance is removed from the cells of the basic screen of the blank gravure form, so that the cycle (a) filling, (b) ablation imaging, (c) inking, (d) printing, and (e) regeneration can be started once again from the beginning. The ultrasonic cleaning system can be operated on at least two different levels, where one level with low sound energy and/or with a liquid which removes only one color is used to remove the remaining ink, whereas the other levels with correspondingly higher sound pressures and/or different cleaning agents are used to remove some or all of the filler material.

In principle, an ablation imaging process can address areas (image pixels) which are smaller than the elements of the basic screen of the gravure form, and in particular ablation imaging can even be carried out essentially independently of the basic screen. Nevertheless, ablation imaging can also conform to the basic screen; that is, it can stand in a certain geometric relationship to it. In the ideal case, the ablation imaging step structures the cells of the basic screen in the manner required by process engineering.

EP 0 813 957 B1, furthermore, discloses another simplification of the production of a gravure form. For this process, the cells of the basic screen of the blank gravure form are filled with a UV ink during the filling process itself; this ink is cured in the cells; and then, to create the image, the cured UV ink is removed from the appropriate cells by thermal ablation, whereupon the image screen is inked again with liquid UV ink. After printing is complete, the gravure form passes through an erasing step—again based on the use of UV ink—so that the form can be used again. This means that only a single process medium is involved in the entire process, a medium which fulfills all of the necessary functions, serving as the erasing fluid, the printing ink, and the filler material. This also means that there are no longer any evaporating solvents or hazardous compounds present, that the undesirable mixing of process media is excluded, and that an increased level of process reliability is achieved at the same time.

The stability of the new filler material is comparable to that of the preceding types of filler materials. Nevertheless, the accumulation of foreign materials in the filler material as a result of impurities (from the room air and the printing process itself, e.g., paper lint) cannot be excluded. The circumstance can be remedied by removing the filler material completely from the cells of the blank gravure form by means of, for example, laser erasing (that is, by using the laser of the image point transfer unit to ablate the filler material completely from the recessed cells of the blank gravure form, writing what amounts to a solid-color image) after a fixed number of renewal cycles.

The device for gravure printing for implementing the process comprises here: to produce the printing form, the cells of the basic screen of the blank gravure form are uniformly filled with a UV printing ink by means of an applicator device in a filling process; the uniformly applied UV ink is cured by a dryer, which can be positioned above the blank gravure form; and then in a following imaging process, the cured UV ink is removed from the cells by thermal ablation by means of an image point transfer device; the gravure form which has now been “screened” in accordance with the desired image is inked with UV ink by means of an inking system; and then a printing process is conducted; whereupon the gravure form is subjected to an erasing step to regenerate it, in that, an applicator device, which dispenses UV ink suitable for completely filling the basic screen; at least one UV dryer, which extends all the way across the width of the printing form and which can be pivoted into and out of position; an image point transfer device for ablation imaging of the surface of the printing form; and a UV printing ink-dispensing inking system are positioned near the rotating gravure form.

Overall, therefore, the cleaning methods or devices cited in the prior art involve either an ultrasonic cleaning system, a high-pressure water cleaner, or the use of the laser of the image point transfer unit for occasional thorough cleaning.

It has been found, however, that, when the cited erasing/cleaning methods are used, either the filler material is not adequately removed in the ultrasound bath or during the erasing process with the high-pressure water cleaner or that an uneconomically long period of time is required to remove the filler material, especially when filler materials are used which are also resistant to solvent-based inks and to the abrasive effects of the printing ink, the paper, and the blades.

The previously mentioned use of the imaging laser to conduct the erasing process is also problematic from an economic standpoint, because the requirements on the image point transfer unit are different from those on an erasing device.

The image point transfer unit is intended above all to remove very small dots and thus to achieve high resolution and good imaging quality. It therefore operates in TEM₀₀ mode. In this mode, the radiation intensity which the laser generates is sharply reduced in comparison to multi-mode operation. For the same reason, short-wavelength lasers are preferred for imaging, whereas lasers with low specific power costs such as TEA-CO₂ lasers cannot be used for imaging.

The image point transfer device requires a modulator, by means of which the laser power can be adjusted precisely to several different levels, but this modulator further attenuates the usable laser power.

The laser power of the image point transfer device must be extremely stable, but such stabilization is expensive.

These requirements are not applicable to the erasing/cleaning process.

In accordance with the previously described prior art, furthermore, the production of the erasable gravure form is preferably carried out within the printing press, which is associated with the disadvantage that the only process steps which come into question are those which can also be used in a printing couple. A second disadvantage is that the printing press cannot print while the erasable gravure form is being regenerated or produced.

Against this background, the invention is therefore based on the task of developing a process and a device for gravure printing of the general type in question by means of which the filler material can be removed reliably and completely within an acceptable amount of time either inside or outside the printing press.

This task is accomplished by the various processes according to Claims 1-8 and by a device according to Claim 9.

The mastery of the erasing process is a precondition for the realization of an erasable and reusable gravure form. In conjunction with the other process steps cited in this invention such as the production of the basic screen, the filling, the curing, the smoothing of the filled surface, the imaging, and the use of the erasable and reusable gravure form in a printing press, all of the process steps which clearly simplify the production of a gravure form and which avoid or significantly reduce the use of galvanic technologies are described.

The sequence of process steps now made possible is as follows:

(a) the gravure form used for printing is cleaned (omitted if this is the first time the form is being used);

(b) the basic screen of the cleaned gravure form is refilled;

(c) the filled gravure form is cured and smoothed;

(d) the gravure form is imaged in a laser platesetter. Thus the printing form is ready for printing. No other chemical process is required; and

(e) after printing is complete, the form can be erased again, filled, and imaged for the next printing order.

Starting from an erasable and reusable gravure form ready for imaging like those which can be delivered as “sleeves” to the printing plant, this gravure form can be produced with about the same setup time as an offset plate. As a result, the process sequences in printing presses in which both gravure and offset printing are done, for example, can be effectively harmonized.

The processes required for the production of an erasable and reusable gravure form can be conducted by means of the device described below, which removes the filler material, fills the form, cures and smooths the filler material, and images the form. Machines for several different steps of the process can be suitably combined in the device; for example, the filling and curing step can be realized together in a coating apparatus.

The erasable and reusable gravure forms thus produced can be used in principle in any gravure press, and the advantages of the erasable and reusable gravure forms such as short setup times until the form is ready for printing, reduction or avoidance of environmentally undesirable galvanic processes, and lowering of production costs can be enjoyed over a broad market base of installed gravure presses.

In the following, several claimed methods for removing the filler material from the basic screen, i.e., erasing the gravure form, are described:

Removing the filler material by means of laser radiation:

The filler material and the residual ink are removed by means of a laser beam, preferably a CO₂ laser beam or a NdYAG or semiconductor laser beam. Laser parameters such as the power density or energy density are adjusted in such a way that the filler material and the residual ink are converted more-or-less completely to the gaseous state, whereas the surface of the gravure form and the basic screen remain unharmed and can be sent on for further use. The process is similar to the imaging process only to the extent that the laser beam is not modulated in accordance with the image data and that the demands on the focusing lenses and on the quality of the laser beam (a Gaussian intensity distribution over the cross section of the laser beam is not required) are lower than those for the imaging process, because the laser beam does not have to be focused so finely. Accordingly, the cleaning step using a laser selected for this purpose with appropriate lenses can be conducted at much lower cost than would be possible with an imaging laser.

The process of removing the filler material can be further supported and accelerated by blowing reactive gas or vapor such as oxygen into the area in which the laser beam interacts with the filler material.

Removing the filler material by means of sodium hydrogen carbonate (NaHCO₃) powder jets:

In contrast to other particle jet methods using quartz sand, for example, or glass beads, it is possible, when blasting with NaHCO₃, to use . . . , and in addition the parameters of the NaHCO₃ powder jets can be adjusted in such a way that, as in the case of laser cleaning, adequate cleaning power is guaranteed without the danger of damage to the surface of the gravure form or to the basic screen. Blasting with NaHCO₃ powder removes both the filler material and residual ink.

Removing the filler material with jets of dry ice:

In contrast to other particle jet methods using, for example, CO₂ pellets, the parameters of dry ice jets can be adjusted in such a way that, as in the case of laser cleaning, adequate cleaning power is guaranteed without the danger of damage to the surface of the gravure form or to the basic screen. Blasting with dry ice powder removes both the filler material and the residual ink (thermoshock effect).

Removing the film material by blasting with crystalline (water) ice:

In contrast to other known blasting methods using, for example, quartz sand or glass beads, blasting with crystalline (water) ice is less abrasive and the jet parameters during blasting can also be adjusted in such a way that, as in the case of laser cleaning, adequate cleaning power is guaranteed without the danger of damage to the surface of the gravure form or to the basic screen. The cleaning process makes use of the phase transition from the solid to the liquid aggregate state and also a thermoshock effect. Blasting with crystalline (water) ice completely removes both the filler material and the residual ink.

Cleaning, i.e., the erasing process, can be carried out in such a way that the ink and all of the filler material are removed, but it can also be carried out in such a way that only the ink is removed. In this case, the surface of the filler material is prepared for a new filling; that is, the filler material is activated by the removal of a possible passivation layer, during which only a small amount of filler material is removed.

To implement the inventive process, an erasing device is used to clean (process step (a)) the gravure form produced according to the sequence of process steps described above. This erasing device removes the residual ink and the filler material completely (or possibly the filler material is removed only partially) from the basic screen of the gravure form. The erasing device can also comprise additional units such as suction, cleaning, and drying units. To implement the actual cleaning step, one or more devices for focusing the laser beams or one or more particle jets aimed at the surface of the gravure form to be erased are moved by one or more motors along a crossbeam by guide devices such as carriages parallel to the longitudinal axis of the rotating gravure form. The rotational speed of the gravure form and the speed along the crossbeam are coordinated with each other so that the distance traveled by the guide devices in the direction parallel to the longitudinal axis of the gravure form during one revolution of the gravure form is less than or equal to the effective width of the laser beam or particle blaster.

When lasers are used, the remaining filler material and the residual ink are preferably converted to the gaseous phase during removal. To prevent the gaseous material from settling on the lenses being used, for example, a suction device is provided to draw off the material carried away by the laser beam, with or without filtration of the evacuated air.

When a particle blaster is used, it is preferable for the blasting agent and the carrier medium of the blasting agent to be pumped out of the working space, preferably in the form of a housing, which surrounds the form cylinder.

In addition, a traversing or nontraversing rinsing device can be provided to remove the cleaning residues. This device can comprise essentially brushes, a liquid jet, and an suction unit or drain. The cleaning liquid is filtered so that it can be reused.

A traversing or nontraversing drying device, furthermore, can also be provided to dry the cleaned gravure form. This drying device comprises a fabric-covered roll or a cloth, a cold and/or hot jet of air, or an IR radiator.

As can be seen, several devices are necessary simply for process step (a), “cleaning the used gravure form” and removing the filler material, namely, for example, a suction device, a rinsing device, and/or drying equipment, which are to be positioned near the gravure form to be cleaned and each of which occupies a certain amount of space, which is very difficult to make available in a gravure press. It is therefore advisable to design the erasing device(s), with or without the additional units mentioned, as a stand-alone device outside the printing press. This offers the additional advantage that there are no longer any process limitations with respect to the space required within the printing press; the press can continue to print during the cleaning process, and, in addition, it becomes possible to use cleaning methods which cannot be used inside the printing press because of the danger of, for example, corrosion.

To accelerate the process of removing the film material, several devices can be arranged along the gravure form, so that each of these devices is required to remove the filler material from only part of the overall length of the cylinder. This has the effect of reducing the amount of time required for the process of removing the filler material.

The basic screen for an erasable gravure form can be produced by several different methods:

For example, the basic screen can be produced by a process similar to that used for conventional gravure forms, namely, it can be engraved or etched in copper. To increase the service life of the gravure form carrying the basic screen, the basic screen is provided with a hard coating of chromium, for example, or of diamond-like carbon, titanium nitride, tungsten carbide, or the like.

The basic screen can also be engraved into ceramic or hard metal alloy coatings. Screen rollers in which, for example, fine screens have been engraved by lasers in plasma-sprayed ceramic coatings are known from Anilox Farbwerken. These types of rollers can also be used as basic screens for reusable gravure forms. They offer the advantage of a very resistant surface, which permits a larger number of reuses.

The basic screen can also be designed as a perforated sleeve, such as that used in rotary screen printing. The sleeve is pulled or shrunk onto a support cylinder or plated directly onto a smooth surface. If the surface does not have sufficient hardness to permit reuse, another coating such as a coating of chromium, diamond-like carbon, titanium nitride, tungsten carbide, or the like can be applied to improve the abrasion resistance of the surface.

As filler material, solid substances are used, preferably polymers, which, during the filling process, are in the form of a liquid with adjustable viscosity or in the form of powder and which crosslink and/or fuse together on the gravure form under the action of UV radiation, temperature, and/or atmospheric moisture.

Preferably, however, a liquid filler material such as polyurethane is used, which crosslinks in the presence of atmospheric moisture but does not crosslink in a dry ambient atmosphere such as that which is present precisely in the filling device, as a result of which the maintenance work on the filling device becomes much easier.

So that no wetting problems occur during the filling of the basic screen with the liquid filling material, the surface energy of a filler material which is in liquid form during the filling process should be less than the surface energy of the basic screen. So that, during printing, the still partially filler material-filled gravure cells can be easily filled with ink and emptied again without difficulty, the surface energy of the cured filler material should be greater than the surface energy of the ink. To increase the abrasion resistance of the filler material to abrasive inks and papers, a powder of a hard material such as aluminum oxide, silicon carbide, or silicon oxide with an ultrafine particle size (typical particle size <1 μm) can be added to the filler material.

The device for filling an erasable gravure form has the task of applying the filler material to the basic screen in such an amount that the cured filler material layer completely fills the cells and covers the entire basic screen with an excess thickness of approximately 10 μm above the height of the cells walls of the basic screen.

The filling process can be carried out by means of a blade system similar to the ink fountain blade/ink fountain roller in an inking couple of an offset press. Instead of a doctor blade, it would also be possible to use a roll doctor with structures suitable for preventing air bubbles from working their way into the filler layer on the basic screen during rapid doctoring.

The screen could also be filled, however, by the use of electrostatic powder coating methods or by spraying methods.

To prevent a filler material which cures in the presence of atmospheric moisture from curing in the filling device, the parts of the filling device which come in contact with the filler material are located in a chamber sealed off against the atmospheric moisture of the environment, in which chamber a sufficient positive pressure of an atmosphere with sufficiently low moisture prevails to ensure that the moisture-dependent crosslinking of the filler material does not start.

After the basic screen of the erasable and reusable gravure form has been coated with the filler material, this filler material must be cured, that is, crosslinked, especially when polymers are used which are applied to the basic screen in the liquid and uncrosslinked or only partially crosslinked state. This crosslinking should not start spontaneously, however; that is, it should not start simply when the two starting materials which will form the polymer are mixed together, because otherwise either the filling device will become unusable through the spontaneous curing of the material, a great deal of maintenance work will be required, or special and expensive components will be required for the filling device. For this reason, it is advisable to use filler materials that begin crosslinking in a defined manner, such as materials which begin to crosslink only under exposure to UV radiation with or without shorter or longer periods of heating to approximately 80-140° either simultaneously or subsequently to the radiation, materials which begin to crosslink only at temperatures above approximately 80-100° C., or materials which being to crosslink only in the presence of moisture.

If the erasable and reusable gravure form is a sleeve, the cylinder which carries the sleeve in the curing device can have a layer of thermal insulation on its surface, e.g., a glass fiber-reinforced epoxy resin layer, so that the heat applied for curing does not flow from the sleeve into the support cylinder. Additional devices for curing the filler material can be:

a UV radiator, with our without reduction of the IR thermal radiation, which irradiates the entire length of the erasable and reusable gravure form or can traverse the gravure form;

an IR radiator, possibly also in combination with a UV radiator, which also irradiates the entire length of the erasable and reusable gravure form or can traverse the same; and

an oven to hold the erasable and reusable gravure form or a closed space with adjustable moisture, which holds the erasable and reusable gravure form, where a closed space containing a gas atmosphere of adjustable composition (adjustable protective atmosphere, e.g., nitrogen) could also be imagined.

During the process of filling the basic screen, an excess of material is applied to the basic screen; to avoid scumming of the gravure form, this excess must be smoothed off again down to the height of the cell walls. This can be done with a polishing medium which has little or no effect on the surface of the basic screen, such as a polishing medium based on aluminum oxide. The polishing medium can be used on flexible polishing disks or polishing belts such as in the so-called superfinishing machines sold by Loeser GmbH. Polishing with a polishing stone as known from the copper polishing of conventional gravure printing cylinders is also possible. The polishing process is over when the filler material in the cells of the basic screen is flush with the tops of the cell walls of the basic screen. This can be determined by the following methods: By measuring the reflection (in the case of a chromium-plated basic screen, the reflection increases when the basic screen starts to appear through the filler material). The measurement can be done integrally and also in a spectrally selective manner at wavelengths at which the filler material is especially absorbent, by measuring the electrical resistance between a metal contact (e.g., a small wheel or brush) and the erasable gravure form, or by some other electrical method, e.g., on the basis of an eddy current measurement or by inductive measurement.

The erasable and reusable gravure form can be designed either as a solid cylinder or as a tube, so that the cylinder can be mounted in any type of gravure press. In addition, the gravure form can be designed as a thin-walled sleeve, which is mounted on a so-called “air cylinder”. The sealing of the slot between the sleeve and the air cylinder can be accomplished by using an ink and solvent-resistant sealing ring, by greasing the slot with a sufficiently solvent-resistant grease, or by applying a silicone sealing compound.

1.-24. (canceled)

25. A process for gravure printing comprising:
providing a blank gravure form with a basic screen designed to accept at least the maximum amount of ink to be transferred during printing, the basic screen having cells;
uniformly filling the cells with filler material by means of an applicator device;
selectively removing the filler material from the cells by thermal ablation by means of an image point transfer device, thereby producing a screened gravure form in accordance with a desired image;
inking the screened gravure form by means of an inking system;
using the gravure form for a gravure printing process; and
removing the filler material and any residual ink using a laser beam produced by a laser device which is separate from the image point transfer device, wherein the laser device is one of a gas laser and a solid state laser.

26. The process of claim 25 wherein the laser device is adjusted to produce a laser beam having an energy density which is sufficient to convert the filler material and any residual ink to the gaseous phase.

27. The process of claim 26 wherein the gaseous phase material is removed by a suction device.

28. The process of claim 25 further comprising injecting a reactive gas or vapor into an area where the laser beam interacts with the filler material.

29. The process of claim 25 wherein the laser beam is moved along the gravure form in the axial direction at a speed while the gravure form rotates, the speed being selected so that the axial distance traveled during one revolution is less than the effective width of the laser beam.

30. The process of claim 29 wherein the laser beam is focused by optical elements which are mounted for movement on a crossbeam.

31. A process for gravure printing comprising:
providing a gravure form with a basic screen designed to accept at least the minimum amount of ink to be transferred during printing, the screen having cells defined by cell walls;
uniformly filling the cells with filler material by means of an applicator device;
selectively removing the filler material from the cells by thermal ablation by means of an image point transfer device, thereby producing a screened gravure form in accordance with a desired image;
inking the screened gravure form by means of an inking system;
conducting a gravure printing process; and
removing the filler material and any residual ink by means of a particle blaster using one of a jet of sodium hydrogen carbonate particles, a jet of dry ice particles, and a jet of water ice particles as a blasting agent.

32. The process of claim 31 wherein the filler material and any residual ink are removed using of a jet of sodium hydrogen carbonate particles.

33. The process of claim 31 wherein the filler material and any residual ink are removed using a jet of dry ice particles.

34. The process of claim 31 wherein the filler material and any residual ink are removed using a jet of water ice particles.

35. The process of claim 25 wherein said filler material is not completely removed from the cells by thermal ablation, the filler material for the next imaging and printing process being applied over filler remaining from the preceding filling of the cells.

36. The process of claim 28 wherein the jet of particles is moved along the gravure form in the axial direction at a speed while the gravure form rotates, the speed being selected so that the axial distance traveled during one revolution is less than the effective width of the jet of particles.

37. The process of claim 31 further comprising evacuating the blasting agent and the removed filler material and residual ink by means of pumps.

38. The process of claim 31 further comprising removing any residues from the gravure form by means of a rinsing device.

39. The process of claim 38 further comprising drying the gravure form by means of a drying device.

40. The process of claim 31 wherein the basic screen of the gravure form is produced by engraving a thermally sprayed ceramic coating using a laser.

41. The process of claim 31 wherein the basic screen of the gravure form is produces by fitting a sleeve onto a smooth support cylinder.

42. The process of claim of claim 31 wherein the basic screen is produced by engraving the basic screen in copper, and coating the engraved copper with a layer of chromium followed by a hard layer selected from the group consisting of diamond, tungsten carbide, and titanium nitride, and having a thickness of 0.1 to 4 μm.

43. The process of claim 31 wherein filler material is applied to the basic screen in such an amount that cured filler material completely covers the basic screen with an excess thickness of about 10 μm above the cell walls.

44. The process of claim 43 further comprising smoothing the cured filler material down to the cell walls of the basic screen using a polishing compound that has substantially no effect on the basic screen.

45. The process of claim 25 wherein the filler material contains an absorber which absorbs radiation of the image point transfer device as well of the laser device used to remove the filler material.

46. The process of claim 25 wherein the filler material crosslinks in the presence of atmospheric moisture but does not crosslink in a dry ambient atmosphere.

47. The process of claim 25 wherein the filler material comprises at least one of monomers and oligomers which begin crosslinking at temperatures above 40° C.

48. The process of claim 25 wherein the filler material contains hard particles of at least one of silicone carbide and aluminum oxide, wherein the particles have a size of less than 10 μm.
